(19) United States
(12) Patent Application Publication
(10) Pub. No.: US 2021/0292205 A1
(43) Pub. Date: Sep. 23, 2021

(54) SYSTEM AND METHOD FOR TREATING MEDICAL SEWAGE CONTAINING SARS-CoV-2 BASED ON NANO GRAPHENE

(71) Applicants: SHAOGUAN UNIVERSITY, Shaoguan (CN); FOSHAN QIONGLU HEALTH TECHNOLOGY CO., LTD, Foshan (CN)

(72) Inventors: Jinsheng CHENG, Shaoguan (CN); Weihong WAN, Shaoguan (CN); Jianying ZHI, Shaoguan (CN)

(21) Appl. No.: 17/332,936

(22) Filed: May 27, 2021

(30) Foreign Application Priority Data
May 27, 2020 (CN) 202010458474.6

(51) Int. Cl. C02F 9/00; C02F 1/00; C02F 1/36; C02F 1/72; C02F 1/48

(52) U.S. Cl. CPC C02F 9/00; C02F 1/001; B82Y 25/00; C02F 1/725; C02F 1/481; C02F 1/36

(57) ABSTRACT

A system for treating medical sewage containing SARS-CoV-2 based on nano graphene, including a medical sewage collection and transportation device, primary and secondary sedimentation tanks, a filtering device, primary, secondary and tertiary graphene sterilization devices, a multiple purification tank, a photocatalytic degradation device, a SARS-CoV-2 deep purification device and a graphene water purification device including at least three stages of graphene water purification units. The disclosure also provides a method for treating the medical sewage containing the SARS-CoV-2 using the above system.

### CROSS-REFERENCE TO RELATED APPLICATIONS

This application claims the benefit of priority from Chinese Patent Application No. 202010458474.6, filed on May 27, 2020. The content of the aforementioned application, including any intervening amendments thereto, is incorporated herein by reference in its entirety.

### TECHNICAL FIELD

This application relates to sewage purification, in particular to a system and method for treating a medical sewage containing SARS-CoV-2 based on nano graphene.

### BACKGROUND

Medical sewage has various sources and very complex composition. Generally speaking, medical sewage contains a large number of pathogenic bacteria, viruses and chemical agents, such as various drugs, disinfectants, diagnostic agents, detergents, and a large number of pathogenic microorganisms, parasite eggs and various viruses, including roundworms. Eggs, hepatitis virus, tuberculosis and dysentery bacteria, etc. It has the characteristics of space pollution, acute infection and latent infection. Compared with industrial wastewater and domestic wastewater, medical wastewater has the characteristics of small water volume and strong pollution. If it is allowed to discharge, it will seriously pollute water sources and spread diseases. It is very easy to cause major public health incidents. Infectious disease hospitals have been more special. The medical sewage discharged by them may contain a large amount of Staphylococcus aureus, Streptococcus pneumoniae, Pseudomonas aeruginosa, Mycobacterium tuberculosis, Escherichia coli, enterovirus, fecal Escherichia coli, Group B streptococcus, Congenital syphilis, cytomegalovirus, endotoxin, etc., and residual parasites, residual drugs, etc. Through epidemiological investigations and bacteriological examinations, it is proved that all the large-scale outbreaks of infectious diseases in China are related to drinking or contact with contaminated water. For example, a large-scale outbreak of hepatitis A occurred in Shanghai in 1988, which was caused by contaminated cockles by fecal vessels carrying the hepatitis A virus (Ye Wanfang, Cai Tongzhang. The outcome of the hepatitis A outbreak in Shanghai in 1988) Prognostic research: 1075 cases were followed up for 5 years . . . [J]. Shanghai Medical Journal, 1993, 16(11): 629-632). How to achieve in-depth purification and discharge of highly pathogenic medical wastewater from infectious hospitals is a problem that any infectious disease hospital needs to face. The industry also puts forward extremely high requirements on the medical wastewater purification technology of infectious disease hospitals. The novel coronavirus-induced pneumonia (COVID-2019) epidemic that has occurred since December 2019 is currently raging around the world. As of noon on May 25, 2020, a total of 5,416,037 people have been diagnosed (84,536 in China), causing significant damage to the health of the people. Judging from the domestic anti-epidemic situation, all 167 large-scale infectious disease hospitals and more than 3,000 infectious departments in general hospitals across the country have undertaken the work of admission and treatment of new crown patients. Studies have shown that the virus survives in the excreta of infected persons and can enter the sewage treatment system through the drainage system (People's Daily Online, Feb. 2, 2020), this directly caused the medical sewage discharged from infectious hospitals to become a high-risk pollution source. While treating patients with the new crown, hospitals also need to pay special attention to the issue of safe discharge of medical sewage containing the new crown virus. The pressure on the hospital has increased sharply. The existing traditional activated sludge method or biofilm method has never considered the new crown virus pollution problem, and cannot fundamentally ensure the safe discharge of medical wastewater from infectious disease hospitals contaminated by the new crown virus. In addition to the relevant standards of the “Water Pollutant Discharge Standards for Medical Institutions” (GB 18466-2005), on Feb. 1, 2020, the Ministry of Ecology and Environment issued the “Technical Plan for Emergency Treatment of Medical Sewage Contaminated by the Novel Coronavirus”, attaching great importance to medical sewage Emissions. Once the new crown virus enters the municipal pipe network or other water sources through discharge, its potential harm to ecological safety, environmental safety and public health is very fatal. Up to now, there is no technology specifically for systematic and in-depth purification of medical sewage containing SARS-CoV-2. Existing traditional medical wastewater purification technologies are also in urgent need of upgrading and transformation, and there is an urgent need for cutting-edge high-efficiency new crown virus-containing medical wastewater deep purification devices or technologies to ensure zero discharge of new crown viruses and protect ecological safety and public health. On the other hand, graphene has excellent antibacterial and blocking activities. For its antibacterial mechanism, researchers have proposed several major mechanisms, such as nanoknife theory, oxidative stress, and encapsulation (Pham VT et al. ACS Nano, 2015, 9(8): 8458-8467). For example, as early as 2010, Akhavan and other scholars proposed that the sharp edges of graphene nanomaterials would cause the destruction of cell membranes and the loss of intracellular RNA (Akhavan O. et al. ACS Nano, 2010, 4(10): 5731-5736). Since then, researchers have continuously discovered this effect (Chen J. et al. J. Nanopart. Res., 2013, 15(5): 1658.). Zou et al. summarized a large number of experiments to dynamically simulate the process of nanosheets passing through the cell membrane. In this process, the graphene nanomaterial acts as a “nano knife”, and its sharp edge penetrates the cell membrane. The author also proposed an “insertion model”, emphasizing the importance of sharp edges and edge density for antibacterial activity (Zou X. et al. J. Am. Chem. Soc., 2016, 138(7): 2064-2077); Duan G, Zhang Y, Luan B, et al. Graphene-Induced Pore Formation on Cell Membranes [J]. Scientific Reports, 2017, 7:42767.

In addition, some researchers have also proposed that the monolayer graphene film can wrap the cell membrane of the bacteria, provide a separate space for the bacteria, isolate it from the surrounding environment, and cannot get the supplement of nutrients and the toxins excreted by itself. Unable to exchange with the external environment, resulting in the death of bacteria. In view of the unique film structure of graphene, this mechanism explanation is widely accepted (Akhavan O. et al. J. Phy. Chem. B., 2011, 115(19): 6279-6288). A study by the Third Military Medical University in China also found that nano-scale graphene and more than 10 kinds of bacteria such as Escherichia coli and Pseudomonas aeruginosa were tested together to have a significant killing effect on the bacteria. Similar to the above description of the mechanism, the author also proposed the “nano knife” model and the mechanism of “starved bacteria”. In addition, the author also proposed that bacteria may swallow tiny graphene into the “belly” and cause its slow death (anonymous. The Third Military Medical University found that nano-scale graphene has a bactericidal effect [J]. Petrochemical Industry, 2016, (7):833-833). The composite of graphene and nano-silver, silver oxide or paramagnetic nanoparticles into various nano-materials superimposes to give graphene nano-materials more excellent bacteria, parasite killing, and blocking effects (Ma Shuanglong. Graphene-like graphite Preparation of olefin and silver-based functional materials and research on water sterilization [D]. Nankai University, 2017; Zhu Zhongjie, Huang Qing. Research progress on antibacterial properties based on graphene and nanocomposites [J]. Journal of Biology, 2018, 35(2): 67-72 etc.). Some researchers even believe that graphene sterilization technology is expected to lead the development of new sterilization technologies in the future, and is safer than traditional antibiotics (nano-level graphene can sterilize and is safer than antibiotics [J]. China Powder Industry, 2016, 000(002): 38-38).

### SUMMARY

In order to make up for the deficiencies in the prior art, the present invention provides a graphene nano-purification system for treating medical sewage containing SARS-CoV-2, which can deeply kill and purify the SARS-CoV-2-containing medical sewage in infectious disease hospitals, and ensure infectious diseases. The hospital's medical wastewater discharges up to the standard. In order to achieve the above objectives, the technical solutions adopted by the present invention are as follows: A graphene nano-purification system for treating medical sewage containing SARS-CoV-2, including a medical sewage collection and transportation device, and the following devices: At least two-stage sedimentation tanks, in which the first-stage sedimentation tank is equipped with a sodium hypochlorite generator; A filtering device, in which at least a three-stage graphene filter screen is provided; At least three-level graphene sterilization device, the graphene sterilization device is filled with superparamagnetic nanoparticles—graphene oxide composite nano material, or graphene sterilant, or a combination of graphene composite material and sterilant; Multiple purification tanks, the multiple purification tanks are provided with an ozone generator, a first ultraviolet generating device, a graphene chemical oxygen demand degrading agent, and the graphene sterilizing agent, and the multiple purification tanks are provided with a communicating spray A leaching liquid storage tank and an ultrasonic micro-nano bubble generator, the nozzle of the ultrasonic micro-nano bubble generator is placed in the multiple purification tank; The photocatalytic degradation device is filled with a graphene photocatalytic degradation agent; the photocatalytic degradation device has a columnar structure, and the material is transparent glass, transparent ceramic or transparent polymer. SARS-CoV-2 deep purification device, the SARS-CoV-2 deep purification device is provided with a transparent casing, and a second ultraviolet generating device and an irradiation device are arranged outside the transparent casing; the material of the transparent casing is transparent ceramics, high-strength transparent glass or High-strength transparent polymer. At least a three-level graphene water purifier, the graphene water purifier is filled with heavy metal adsorption graphene nanocomposite materials, or large surface area graphene nanomaterials, or graphene porous ceramic materials. Furthermore, a peristaltic pump is provided at the water inlet of the new crown virus deep purification device to control the sterilization process by adjusting the flow rate; a 3-8-stage decelerating screen is installed inside to delay the flow of water and enable the water to be fully irradiated with ultraviolet rays. Effectively, completely kill the remaining pathogenic bacteria such as SARS-CoV-2, Pseudomonas aeruginosa and E. coli. The deceleration screen is made of stainless steel or polytetrafluoroethylene (PTFE), and its aperture is between 10-400. The irradiation device is a ⁶⁰Co-γ irradiation device, and a dosimeter for measuring irradiation is provided outside the SARS-CoV-2 deep purification device. The second ultraviolet generating device is a 15-40 W ultraviolet lamp. Further, the graphene filter screen has three stages, the meshes of which are gradually increased, and are sequentially arranged in the front, middle, and rear sections of the filter device along the water flow direction. Among them, the mesh number of the first-level graphene filter is 10-30 mesh, the mesh number of the second-level graphene filter is 30-80 mesh, and the mesh number of the third-level graphene filter is 80-400 mesh. Filter solid wastes of different sizes to prevent clogging of the filter device. Further, in the superparamagnetic nanoparticle—graphene oxide composite nanomaterial, the material of the superparamagnetic nanoparticle is any one or more of γ-Fe₂O₃, Fe₃O₄, Y₂O₃, MnZn, and CoFe₂O₄, and its particle size Less than 10 nm; Graphene oxide carrier and superparamagnetic materials with particle size less than 10 nm have excellent antibacterial activity. After the composite nanomaterial is formed, superimposed sterilization effect can be produced, which can further kill Pseudomonas aeruginosa and large intestine remaining in medical sewage Possible pathogenic bacteria in water such as bacillus, conjugative bacillus, SARS-CoV-2, cholera, Shigella dysenteriae, Salmonella, Klebsiella, schistosomiasis pathogen. The superparamagnetic nanoparticle—graphene oxide composite nanomaterial is wrapped with 10-325 mesh recycled fiber cloth or glass fiber cloth. The graphene sterilant is silver/graphene oxide, silver/cobalt ferrite/graphene, ferroferric oxide/graphene oxide, yttrium oxide/graphene, bismuth oxychloride/graphene, bismuth oxybromide/oxide Any one or more of graphene, titanium dioxide/graphene oxide, titanium dioxide/silver/graphene oxide, and zinc oxide/graphene oxide; the size of the graphene sterilant is between 2-500 nm. The combination of the graphene composite material and the sterilant can be a chlorine ball-graphene nanocomposite material, a chlorine ball grafted quaternary ammonium quaternary phosphonium salt solid bactericide, 1-bromo-3-chloro-5,5-dimethyl Gehydantoin-graphene nanocomposite, 2,2-Dibromo-3-nitrilopropionamide-graphene nanocomposite, 1,3-dibromo-5,5-dimethylhydantoin-graphene nanocomposite, 2-bromo-2-Nitro-styrene-graphene nanocomposite, benzyl dibromoacetate-graphene nanocomposite, dodecyldimethylbenzylammonium bromide-graphene nanocomposite, bronopol-graphene Nanocomposites, tribromophenol-graphene nanocomposites, 4-bromo-2,5-dichlorophenol-graphene nanocomposites, 1,2-dibromo-2,4-dicyanobutane-graphite Ene nanocomposite, α-bromocinnamaldehyde-graphene nanocomposite, 2-butene-1,4-diol bis(bromoacetate) ester-graphene nanocomposite, 2,2-dibromo-2-Nitroethanol-graphene nanocomposite, N-(4-bromo-2-methylphenyl)chloroacetamide-graphene nanocomposite, 2,2-dibromo-3-cyanopropionamide-graphene Nanocomposites, solid ternary stable chlorine dioxide-graphene nanocomposites, ferrate-graphene nanocomposites, azoxystrobin-graphene nanocomposites, ethyl phosphate aluminum-graphene nanocomposites, high Any one or more of polyiodine-graphene nanocomposite materials. The graphene composite material may be graphene, graphene oxide, boron-doped graphene, nitrogen-doped graphene nanosheets, graphene nanoribbons, graphene nanotubes, graphene nanoclusters, graphene nanofibers, graphite Any one or more of ene three-dimensional framework materials, graphene quantum dots, etc. Further, the spray liquid storage tank stores any one of nano-ionized water, alkaline ionized water, alkaline reduced water, electrolyzed water, negative ionized water, and fluorinated water. Further, the graphene chemical oxygen demand degradation agent is large surface area graphene, boron-doped graphene, CoFe₂O₄/graphene oxide nanocomposite material, ferrous sulfate/graphene nanocomposite material, bentonite/graphene Nanocomposites, vermiculite/graphene nanocomposites, serpentine/graphene nanocomposites, titanium dioxide/graphene nanocomposites, graphene oxide/titanium dioxide nanoparticles, graphene oxide/titanium dioxide nanoribbons, graphene oxide/Titanium dioxide nanotubes, graphene/titanium dioxide nanorods, phosphotungstic acid/graphene oxide, tungsten trioxide/graphene oxide, zinc oxide/graphene oxide composite materials, degraded by direct action or Photocatalytic degradation of residual organic matter and chemical oxygen demand in water. Further, the graphene photocatalytic degradation agent is graphene oxide/titanium dioxide nanoparticles, graphene/titanium dioxide nanoparticles, graphene oxide/titanium dioxide nanoribbons, graphene/titanium dioxide nanoribbons, graphene oxide/titanium dioxide nanotubes, Graphene/titanium dioxide nanotubes, graphene oxide/titanium dioxide nanorods, graphene/titanium dioxide nanorods, phosphotungstic acid/graphene oxide, phosphotungstic acid/graphene, tungsten trioxide/graphene oxide, tungsten trioxide/graphite Olefin, zinc oxide/graphene oxide, zinc oxide/graphene, cuprous oxide/graphene, cuprous oxide/graphene oxide, bismuth tungstate/graphene, silver phosphate/graphene, molybdenum disulfide/graphene, Any one or more of trimanganese tetroxide/graphene oxide. The graphene photocatalytic degradation agent is wrapped with 10-400 mesh recycled fiber cloth or glass fiber cloth.

Further, the heavy metal adsorption graphene nanocomposite material is graphene oxide, hydroxylated graphene, carboxylated graphene, chitosan modified graphene oxide, glutaraldehyde-coupled graphene oxide, chitosan modified Hydroxylated graphene, acid salt nanotube-graphene oxide, hydroxyapatite-graphene oxide, N-(trimethoxysilylpropane) ethylenediamine triacyl oxide graphene, hydroxylated carbon nanotube-graphite oxide Olefin, titanium pillared montmorillonite-graphene oxide, aluminum oxide-graphene oxide, polyaluminum chloride-graphene oxide, polyhydroxyaluminum pillared vermiculite, polyhydroxyaluminum pillared vermiculite-graphene oxide, 13X molecular sieve, sodium alginate-graphene oxide, EDTA-graphene oxide, polyamide-amine dendrimer porous silica gel, polyamide-amine dendrimer-graphene oxide, N-(2,3-epoxypropyl)iminodiacetic acid modified any one of graphene oxide to remove heavy metals such as copper, nickel, lead, cadmium, mercury, arsenic, total chromium, and hexavalent chromium remaining in the water. The heavy metal adsorption graphene nanocomposite material is wrapped with 10-325 mesh recycled fiber cloth or glass fiber cloth. The large surface area graphene nanomaterial is a single-layer graphene nanosheet, a three-dimensional mesoporous graphene nanomaterial, a three-dimensional macroporous graphene nanomaterial, a graphene aerogel, a graphene nanofiber, or a graphene organic skeleton composite nano Any of the materials can effectively absorb the residual chlorine and other odorous substances in the sewage, polycyclic aromatic hydrocarbons, residual antibiotics and other drugs, volatile phenols, biological agents, chemical solvents, oil stains and other residual pollutants, as well as residual lead, chromium, mercury, etc. Heavy metal contaminants. The large surface area graphene nano material is wrapped with 10-325 mesh recycled fiber cloth or glass fiber cloth. Further, the graphene porous ceramic material is wrapped with 10-325 mesh recycled fiber cloth or glass fiber cloth, and the preparation process is as follows: S101. Select silicon carbide or boron carbide porous ceramic material as the substrate; S202. The substrate is subjected to ultrasonic treatment, gradient immersion in a copper dichloride or cobalt dichloride solution, and vacuum-dried after being pulled, and then the temperature is programmed in an inert gas atmosphere to obtain a silicon carbide or boron carbide porous surface with a metal film Ceramic material raw materials; S103. Put the raw material obtained in step S202 into a chemical vapor deposition reaction chamber and seal, and raise the temperature (heat to 900° C., 950° C., 1000° C., 1050° C. at a temperature rise rate of 10° C./min, and the constant temperature time lasts for 10 minutes and 30 minutes, respectively, 60 minutes) and then pass methane or acetylene (inject 1, 5, 10, 15 ml/min unit), adjust the hydrogen flow under the protection of argon (adjust the hydrogen flow to 30 ml/min, the reaction time is 30 minutes, 60 Minutes, 150 minutes, 180 minutes, 210 minutes, 240 minutes, 300 minutes). React S104. After the reaction, stop feeding methane, keep the flow of hydrogen and argon unchanged, and cool down (control the temperature drop rate from 10° C./min to 400° C., and then naturally cool to room temperature) to obtain the graphene porous ceramic material. The above-mentioned graphene sterilization devices and graphene water purification devices are all columnar structures, and the material is any one of stainless steel, ceramics or high-strength polymer materials. Wherein, the polymer material is polypropylene (PP), polysulfone (PS), sulfonated polysulfone (SPS), polyethersulfone (PES), polyvinylidene fluoride (PVDF), polytetrafluoroethylene (PTEE), Polycarbonate (PC), polyether ether ketone (PEEK) any one of them. The present invention also provides a process for applying the graphene nano-purification system for treating medical sewage containing the SARS-CoV-2. After the medical sewage is collected, it goes through the following processing steps in sequence: S201. Settling solid wastes and suspended solids in the first-level sedimentation tank; S202, filtering by the filtering device; S203, the first-level graphene sterilization device performs preliminary sterilization; S204. The multiple purification tanks preliminarily kill the SARS-CoV-2, multiple sterilizations, and reduce chemical oxygen demand; S205, photocatalytic degradation treatment of the photocatalytic degradation device; S206. The second-level sedimentation tank further settles suspended solids and kills germs (including the SARS-CoV-2) and parasites; S207, successively pass through the graphene sterilization device of the second and third stages for further sterilization; S208. The first-level graphene water purification device processes heavy metals; S209. The new crown virus deep purification device further kills the new crown virus in depth; S2010, processing peculiar smell substances and heavy metals through the graphene water purification device of the second and third stages in sequence. Compared with the prior art, the present invention has the following beneficial technical effects: In the graphene nano-purification system and process for treating medical sewage containing the SARS-CoV-2 of the present invention, the ultrasonic micro-nano bubble generator can generate micro-nano bubbles, and the novel coronavirus can be deeply killed by using the instantaneous high temperature, high pressure and high energy release of the micro-nano bubbles. Combine the multi-stage graphene water purification device and the graphene sterilization device to further kill and block a variety of pathogenic bacteria (including the new crown virus), parasites and hundreds of pollutants in infectious hospital medical sewage Or deep purification can ensure the discharge of medical sewage from infectious disease hospitals up to the standard, thereby ensuring the safety of people's lives, environmental safety and life health.

### BRIEF DESCRIPTION OF THE DRAWINGS

The FIGURE is a structural diagram of the graphene nano-purification system for treating medical sewage containing SARS-CoV-2 according to the present invention. Among them: 1. Collection and conveying device; 2. Primary sedimentation tank; 3. Filter device; 4. Primary graphene sterilization device; 5. Spray liquid storage tank; 6. Ultrasonic micro-nano bubble generator; 7. Multiple Purification tank; 8. Ozone generator; 9. First ultraviolet generating device; 10. Graphene chemical oxygen demand degrading agent; 11. Graphene sterilizing agent; 12. Photocatalytic degradation device; 13. Secondary sedimentation tank; 14. Two-stage graphene sterilization device; 15. Three-stage graphene sterilization device; 16. One-stage graphene water purification device; 17, SARS-CoV-2 deep purification device; 18. Two-stage graphene water purification device; 19. Three-stage graphene water purification device; 20. Sodium hypochlorite generator; 21. Second ultraviolet generating device; 22. Irradiation device.

### DETAILED DESCRIPTION OF EMBODIMENTS

In the following description, many specific details are explained in order to fully understand the present invention. However, the present invention can be implemented in many other ways different from the description herein, and those skilled in the art can make similar popularizations without violating the connotation of the present invention. Therefore, the present invention is not limited by the specific embodiments disclosed below.

### EXAMPLE 1

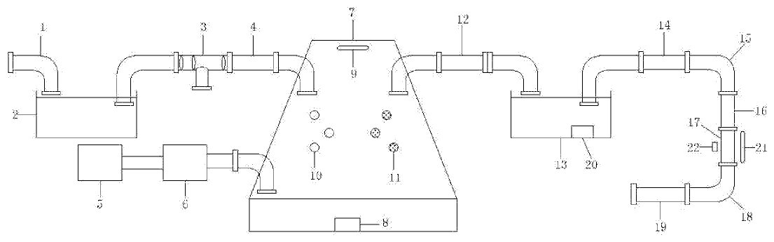

As shown in FIG. 1, a graphene nano-purification system for treating medical sewage containing SARS-CoV-2 includes a medical sewage collection and transportation device 1, a first-stage sedimentation tank 2, a filter device 3, and a first-stage graphene sterilization device 4 connected in sequence The spray liquid storage tank 5 is connected to the ultrasonic micro-nano bubble generator 6; the output end of the first-level graphene sterilization device 4 and the nozzle of the ultrasonic micro-nano bubble generator 6 are placed in the multiple purification tank 7. The multiple purification tank 7 is provided with an ozone generator 8 and a first ultraviolet generating device 9, and a graphene chemical oxygen demand degrading agent 10 and a graphene sterilizing agent 11 are cast. The multiple purification tank 7 is also connected to the photocatalytic degradation device 12, the second-stage sedimentation tank 13, the second-stage graphene sterilization device 14, the third-stage graphene sterilization device 15, the first-stage graphene water purification device 16, and the new crown virus deep purification device. Device 17, two-stage graphene water purification device 18, and three-stage graphene water purification device 19. Among them, the secondary sedimentation tank 13 is also provided with a sodium hypochlorite generator 20; the new crown virus deep purification device 17 is provided with a transparent casing, and a second ultraviolet generating device 21 and an irradiation device 22 are provided outside the transparent casing. The specific structure and treatment process of the graphene nano-purification system for treating medical sewage containing the SARS-CoV-2 of this embodiment are as follows:

1. Medical sewage pretreatment process The medical sewage from the infectious disease hospital or the infectious department of a general hospital enters the first-level sedimentation tank 2 through the collection and conveying device 1 to settle solid waste and suspended solids. The first-stage sedimentation tank 2 is a cylindrical tank with a depth of 2.0 m and a diameter of 3.0 m. The bottom of the tank is provided with a sewage valve, which can periodically remove the settled solid waste and suspended matter. After the medical sewage settles, it is transported to the filtering device 3 for filtering, so as to further remove the residual solid waste in the sewage. The filtering device 3 is a columnar structure with a diameter of 20 cm and a length of 15 cm. A 10-mesh primary graphene filter, a 30-mesh secondary graphene filter, and an 80-mesh three-stage graphene filter are respectively arranged at the front, middle, and rear ends along the water flow direction. Grade graphene filter. The bottom of the middle section of the filter device 3 is also provided with a sedimentation tank, and a discharge valve is provided in the sedimentation tank to remove the settled residual solid waste and prevent the filter device 3 from clogging.

The medical sewage enters the columnar first-level graphene sterilization device 4 after being filtered. The first-level graphene sterilization device 4 is filled with superparamagnetic nanoparticles-graphene oxide composite nanomaterials, which can produce superimposed sterilization effects to remove some residual parasites and pathogenic bacteria in the medical sewage of infectious disease hospitals (Such as Pseudomonas aeruginosa, Escherichia coli, conjugate bacillus, SARS-CoV-2, cholera, Shigella dysentery, Salmonella, Klebsiella, Schistosomiasis pathogens and other possible pathogens in water). The superparamagnetic nanoparticle-graphene oxide composite nanomaterial is wrapped with 50 mesh regenerated fiber cloth, wherein the material of the superparamagnetic nanoparticle is γ-Fe₂O₃, and its average particle size is less than 10 nm. The medical sewage sterilized by the first-level graphene sterilization device 4 is discharged into the multiple purification tank 7 for the next purification treatment.

2. The SARS-CoV-2 and other pathogenic bacteria further killing process The spray liquid storage tank 5 stores fluorinated water. The fluorinated water is input into the ultrasonic micro-nano bubble generator 6 through the traction pump and the delivery pipe. The ultrasonic micro-nano bubble generator 6 works to generate ultrasonic micro-nano bubbles. The power source high-pressure gas-water delivery pump is used for transportation, and the ultrasonic micro-nano bubbles enter the medical sewage in the multiple purification tank 7 through the atomization nozzle for deep purification. Ultrasonic micro-nano bubble generator 6 can generate air flow through accessory parts, and then through the intermittent pulse pneumatic or hydraulic components inside the ultrasonic micro-nano bubble generator to impact the mechanical vibration spring titanium manganese phosphor steel sheet water in the frequency-adjustable seismic cavity The high-frequency resonance of 10000-150000 times per second can be generated through the fine-toothed frequency adjustment screw at the tail of the shock cavity. The resonance frequency of the mechanical shock spring titanium manganese phosphor steel sheet can be adjusted (thereby controlling the particle size, fineness, density, and high frequency of the air bubbles). Resonance), and then pulverize the ozone airflow to produce a large number of ultrasonic micro-nano ozone bubbles in the range of 0.01 microns to 20 microns. These ultrasonic micro-nano ozone bubbles have the characteristics of high interface zeta potential, high mass transfer efficiency, and pressurized dissolved gas to precipitate bubbles. The water body stored in the spray liquid storage tank 6 can promote the efficient formation of ultrasonic micro-nano bubbles.

The principle of the killing process in this part is: Ultrasonic micro-nano bubbles float and separate at high speed in water droplets. With their physical properties of gas and water, the micro-nano bubbles shrink sharply from “μ m” micron size to “nm” nano size, and are finally compressed. When the bubbles are broken, high energy is released; at the same time, the surface of the ultrasonic ozone micro-nano bubbles is negatively charged, which is easy to adsorb positively charged organic matter and suspended matter in the water; when the bubbles are crushed, an instant high temperature and high pressure environment is generated, releasing a lot of energy, And produce .OH free radicals at the air-liquid interface, which are effective against SARS-CoV-2, Pseudomonas aeruginosa, Escherichia coli, conjugate bacilli, cholera, Shigella dysenteriae, Salmonella, Klebsiella, and Schistosomiasis remaining in medical sewage Pathogens and other possible pathogens (parasites) in water are deeply killed and inactivated.

3. Other multiple sterilization and degradation chemical oxygen demand purification processes in multiple purification tanks.

The multiple sterilization process in this part is ozone sterilization by the ozone generator 8, ultraviolet sterilization by the first ultraviolet generator 9, and graphene sterilization agent 11 for sterilization; the graphene sterilization agent 11 is silver/Cobalt Ferrite/Graphene. The chemical oxygen demand is degraded by adding graphene chemical oxygen demand degrading agent 10, which is a ferrous sulfate/graphene nanocomposite material, which degrades residual organic matter and chemical oxygen demand in water through direct action or photocatalysis. The multiple purification tank 7 is a square tank with a length of 10 m and a depth of 3.0 m. The bottom has a drain valve and an adjustable speed agitator. The non-sedimentation time is disturbed by stirring to make the sterilization and COD degradation more thorough.

4. Deep purification process of medical sewage The medical sewage purified by the multiple purification tanks 7 enters the photocatalytic degradation device 12 to further degrade some residual drugs, residual azo dyes and other organic pollutants in the medical sewage. The photocatalytic degradation device 12 is a columnar body made of transparent glass, and is filled with a graphene photocatalytic degradation agent wrapped in a 50-mesh recycled fiber cloth. The graphene photocatalytic degradation agent is graphene oxide/titanium dioxide nanoparticles, which can catalytically degrade azo dyes such as residual drugs in medical sewage, residual reactive red 195, methyl orange, rhodamine B, and phenol under light conditions. Oxalic acid, organic halides and other residual organic pollutants. The medical sewage after photocatalytic degradation enters the secondary sedimentation tank 13 to further settle the suspended solids, and the sodium hypochlorite generator 20 is turned on during the non-sedimentation time to further kill the remaining pathogenic bacteria and parasites

A waste discharge valve is arranged under the secondary sedimentation tank 13 to facilitate the regular removal of the solid waste after the settlement. The medical sewage after re-sedimentation enters the secondary graphene sterilization device 14 for secondary sterilization. The secondary graphene sterilization device 14 is a stainless steel cylinder filled with a graphene sterilant. The graphene sterilizing agent is titanium dioxide/silver/graphene oxide, and the size is between 10-100 nm. The medical sewage after the secondary sterilization enters the tertiary graphene sterilization device 15 for tertiary sterilization. The three-stage graphene sterilization device 15 is filled with a chlorine ball grafted quaternary ammonium quaternary phosphonium salt solid bactericide. The medical sewage after the tertiary sterilization enters the first-level graphene water purification device 16, and the first-level graphene water purification device 16 is filled with heavy metal adsorption graphene nanocomposite materials. The heavy metal adsorption graphene nanocomposite material is wrapped with 10-325 mesh recycled fiber cloth or glass fiber cloth. The heavy metal adsorption graphene nanocomposite material is graphene oxide modified by chitosan to remove heavy metals such as copper, nickel, lead, cadmium, mercury, arsenic, total chromium, and hexavalent chromium remaining in the water. The medical sewage purified by the first-level graphene water purification device 16 enters the SARS-CoV-2 deep purification device 17. The novel coronavirus deep purification device 17 is a cylinder made of transparent glass, the second ultraviolet generating device 21 is a 30 W ultraviolet lamp, which is arranged above the cylinder, and the irradiation device 22 is a ⁶⁰Co-γ irradiation device, which is arranged below the cylinder. Through the effect of ultraviolet radiation and ⁶⁰Co-γ radiation, the remaining SARS-CoV-2 and other pathogenic bacteria are further killed. The representative radiation dose of ⁶⁰Co-γ irradiation is 10 kGY, and it is measured by a pre-installed dosimeter. The new crown virus deep purification device 17 is equipped with a peristaltic pump at the water inlet to control the sterilization process by adjusting the flow rate; there is a 5-level decelerating screen made of polytetrafluoroethylene with an aperture between 10 and 100 to delay the water body Flow, so that the water body can fully obtain the effect of ultraviolet radiation, so as to completely kill the residual pathogenic bacteria such as new crown virus, Pseudomonas aeruginosa and E. coli. The medical water body that has been deeply purified by the SARS-CoV-2 deep purification device 17 flows into the secondary graphene water purification device 18. The secondary graphene water purification device 18 is filled with a large surface area graphene nano material, and the large surface area graphene nanocomposite material is graphene aerogel, which can effectively adsorb odorous substances such as residual chlorine in sewage and polycyclic aromatic hydrocarbons, Residual antibiotics and other drugs, volatile phenols, biological agents, chemical solvents, oil stains and other residual pollutants, as well as residual lead, chromium, mercury and other heavy metal pollutants. The large surface area graphene nano material is wrapped with 80 mesh recycled fiber cloth. After being purified by the secondary graphene water purifier 18, the water flows into the tertiary graphene water purifier 19. The three-stage graphene water purification device 19 is filled with graphene porous ceramic material wrapped with 100 mesh recycled fiber cloth or glass fiber cloth to further remove trace pollutants remaining in the water. The preparation process of the graphene porous ceramic material is as follows:

In the first step, a commercially available silicon carbide porous ceramic material is selected as the substrate. In the second step, the substrate is subjected to ultrasonic treatment, gradient immersion in a copper dichloride solution, and vacuum-dried after being pulled, and then the temperature is programmed through an inert gas atmosphere to obtain a raw material of silicon carbide porous ceramic material with a metal film on the surface. In the third step, the raw materials obtained in the second step are put into the chemical vapor deposition reaction chamber for sealing, the air tightness of the high-temperature reaction chamber is checked, the residual gas in the high-temperature reaction chamber is discharged under a protective atmosphere, and then the temperature is programmed. Heat to 900° C., 950° C., 1000° C., 1050° C. at a temperature increase rate of 10° C./min. The constant temperature time lasts for 10 minutes, 30 minutes, and 60 minutes respectively, and then enter 1, 5, 10, 15 ml/min units For methane, adjust the hydrogen flow rate to 30 ml/min, and the reaction time is 30 minutes, 60 minutes, 150 minutes, 180 minutes, 210 minutes, 240 minutes, and 300 minutes. After the reaction, stop feeding methane, keep the flow of hydrogen and argon unchanged, control the cooling rate from 10° C./min to 400° C., and then naturally cool to room temperature to obtain the graphene porous ceramic material. The primary, secondary, and tertiary graphene sterilization devices are all cylindrical, and the primary, secondary, and tertiary graphene water purification devices are also cylindrical, and their materials are all stainless steel, ceramic or polycarbonate Any kind of. The water body that has been deeply purified by the above process is sampled and tested in accordance with the “Water Pollutant Discharge Standard for Medical Institutions” (GB 18466-2005) to test various indicators to obtain qualified discharge of medical purified water. The following table is a list of indicators after purification of medical sewage from an infectious disease hospital in Guangdong that applies the process of the present invention. All indicators meet the requirements of GB 18466-2005 (the SARS-CoV-2 had not specific in this standard, and this process has not been detected after purification).

TABLE 1
The technical index table after the process of this
embodiment purifies the sewage of each medical unit
of an infectious disease hospital in Guangdong.

| | Requirement of GB | | | |
|---|---|---|---|---|
| | 18466-2005 | | | |
| | The official | unit of | Index after | Individual |
| Items | value | measurement | purification | judgment |
| Suspended | ≤20 | mg/L | 9 | qualified |
| matter (SS) | | | | |
| pH | 6-9 | / | 8.1 | qualified |
| COD_{Cr} | ≤60 | mg/L | 47 | qualified |
| BOD_{S} | ≤20 | mg/L | 15 | qualified |
| NH₃—N | ≤15 | mg/L | 10.3 | qualified |
| Total residual | ≤0.5 | mg/L | 0.13 | qualified |
| chlorine | | | | |
| Fecal coliforms | ≤500 | MPN/L | 117 | qualified |
| Enteric | Must not be | mg/L | Not detected | qualified |
| pathogens | checked out | | | |
| Enterovirus | Must not be | mg/L | Not detected | qualified |
| | checked out | | | |
| Mycobacterium | Must not be | mg/L | Not detected | qualified |
| tuberculosis | checked out | | | |
| Hexavalent | ≤0.5 | mg/L | 0.39 | qualified |
| chromium | | | | |
| Total chromium | ≤1.5 | mg/L | 1.26 | qualified |
| Total cadmium | ≤0.1 | mg/L | 0.07 | qualified |
| Total mercury | ≤0.05 | mg/L | 0.04 | qualified |
| Total arsenic | ≤0.5 | mg/L | 0.19 | qualified |
| Total lead | ≤1.0 | mg/L | 0.41 | qualified |
| Volatile Phenol | ≤0.5 | mg/L | 0.27 | qualified |
| Total cyanide | ≤0.5 | mg/L | 0.34 | qualified |
| Anionic | ≤5 | mg/L | 3.17 | qualified |
| Surfactant | | | | |
| Animal and | ≤5 | mg/L | 1.42 | qualified |
| vegetable oils | | | | |
| SARS-CoV-2 | No | No | Not detected | / |
| | standard | standard | (Virus titer | |
| | | | before | |
| | | | purification | |
| | | | was | |
| | | | 9.17 × 10⁵ | |
| | | | PFU/ml) | |

### Example 2

Compared with Example 1, this embodiment differs in the following:

1. Medical sewage pretreatment process 1. The first-stage sedimentation tank is a rectangular tank with a length of 2 m, a width of 1.5 m and a depth of 1.6 m, and the sewage valve is installed on the side wall of the tank. 2. The filter device 3 is a columnar structure with a diameter of 20 cm and a length of 10 cm. The number of first-level graphene filter meshes is 15, the number of second-level graphene filter meshes is 40, and the number of third-level graphene filter meshes is 90.3. The superparamagnetic nanoparticle-graphene oxide composite nanomaterial is wrapped with 120 mesh glass fiber cloth. The material of the superparamagnetic nanoparticle is CoFe₂O₄, and its average particle size is less than 10 nm.

2. The SARS-CoV-2 and other pathogenic bacteria are in the process of further killing 1. Alkaline ionized water is stored in the spray liquid storage tank 5.

3. In other multiple sterilization and degradation chemical oxygen demand purification processes in multiple purification tanks 1. Graphene sterilizing agent 11 is zinc oxide/graphene oxide; graphene reducing chemical oxygen demand degradation agent 10 is phosphotungstic acid/graphene oxide nanocomposite material 2. The multiple purification tank 7 is a rectangular tank with a length of 5 m, a width of 3.5 m, and a depth of 3.0 m. There are drain valves at the bottom and side walls of the tank. 4. In the deep purification process of medical sewage 1. The photocatalytic degradation device 12 is a cylindrical body made of transparent ceramic material, filled with a graphene photocatalytic degradation agent wrapped with 80 mesh glass fiber cloth; the graphene photocatalytic degradation agent is tungsten trioxide/graphene oxide. 2. The graphene sterilizing agent in the secondary graphene sterilization device 14 is bismuth oxybromide/graphene oxide, and the size is between 5-150 nm.

4. The filler of the tertiary graphene sterilization device 15 is 2,2-dibromo-3-nitrilopropionamide (DBNPA)-graphene nanocomposite material. 4. The heavy metal adsorption graphene nanocomposite material in the first-level graphene water purification device 16 is a graphene oxide nanocomposite material coupled with glutaraldehyde.

5. The new crown virus deep purification device 17 is a transparent ceramic cylinder, and the representative radiation amount of ⁶⁰Co-γ irradiation is 9kGY; the deceleration screen has 6 levels, made of stainless steel, and the aperture is between 20-60.

6. The large specific surface graphene nanocomposite material in the secondary graphene water purification device 18 is a three-dimensional macroporous graphene nanomaterial, which is wrapped with a 200-mesh recycled fiber cloth.

7. In the preparation process of the graphene porous ceramic material, the substrate in the first step is the boron carbide porous ceramic material, and the gas introduced in the third step is changed from methane to acetylene. 8. The material of the primary, secondary, and tertiary graphene sterilization devices and the primary, secondary, and tertiary graphene water purification devices is polypropylene. The water body that has been deeply purified by the above process is sampled and tested in accordance with the “Water Pollutant Discharge Standard for Medical Institutions” (GB 18466-2005) to test various indicators to obtain qualified discharge of medical purified water. The following table is a list of various indicators after purification of medical sewage from an infectious disease hospital in Hubei applying the process of the present invention. All indicators meet the requirements of GB 18466-2005 (the new crown virus is not specific in the country, and this process has not been detected after purification).

TABLE 2
Technical index table after purification of sewage
from various medical units of an infectious disease
hospital in Hubei by the process of this embodiment

| | Requirement of GB | | | |
|---|---|---|---|---|
| | 18466-2005 | | | |
| | The official | unit of | Index after | Individual |
| Items | value | measurement | purification | judgment |
| Suspended | ≤20 | mg/L | 7.5 | qualified |
| matter (SS) | | | | |
| pH | 6-9 | / | 7.3 | qualified |
| COD_{Cr} | ≤60 | mg/L | 55 | qualified |
| BOD_{S} | ≤20 | mg/L | 17 | qualified |
| NH₃—N | ≤15 | mg/L | 9.6 | qualified |
| Total residual | ≤0.5 | mg/L | 0.31 | qualified |
| chlorine | | | | |
| Fecal coliforms | ≤500 | MPN/L | 69 | qualified |
| Enteric | Must not be | mg/L | Not detected | qualified |
| pathogens | checked out | | | |
| Enterovirus | Must not be | mg/L | Not detected | qualified |
| | checked out | | | |
| Mycobacterium | Must not be | mg/L | Not detected | qualified |
| tuberculosis | checked out | | | |
| Hexavalent | ≤0.5 | mg/L | 0.23 | qualified |
| chromium | | | | |
| Total chromium | ≤1.5 | mg/L | 1.12 | qualified |
| Total cadmium | ≤0.1 | mg/L | 0.03 | qualified |
| Total mercury | ≤0.05 | mg/L | 0.02 | qualified |
| Total arsenic | ≤0.5 | mg/L | 0.14 | qualified |
| Total lead | ≤1.0 | mg/L | 0.39 | qualified |
| Volatile Phenol | ≤0.5 | mg/L | 0.22 | qualified |
| Total cyanide | ≤0.5 | mg/L | 0.28 | qualified |
| Anionic | ≤5 | mg/L | 2.36 | qualified |
| Surfactant | | | | |
| Animal and | ≤5 | mg/L | 2.11 | qualified |
| vegetable oils | | | | |
| SARS-CoV-2 | No | No | Not detected | / |
| | standard | standard | (Virus titer | |
| | | | before | |
| | | | purification | |
| | | | was | |
| | | | 9.17 × 10⁵ | |
| | | | PFU/ml) | |

The above are only the preferred embodiments of the present invention and are not intended to limit the present invention. Although the present invention has been described in detail with reference to the embodiments, for those skilled in the art, it is still possible for those skilled in the art to compare what has been described in the foregoing embodiments. Modifications to the technical solutions, or equivalent replacements of some of the technical features, but any modifications, equivalent replacements, improvements, etc. made within the spirit and principle of the present invention should be included in the protection scope of the present invention.

What is claimed is:

1. A system for treating a medical sewage containing SARS-CoV-2 based on nanographene, comprising:
a medical sewage collection and transportation device;
a primary sedimentation tank, equipped with a sodium hypochlorite generator;
a secondary sedimentation tank;
afiltering device;
a primary graphene sterilization device;
a secondary graphene sterilization device;
a tertiarygraphene sterilization device;
a multiple purification tank;
a photocatalytic degradation device;
a SARS-CoV-2 deep purification device; and
a graphene water-purification device comprising at least three stages of graphene water-purification units;
wherein the filtering device is provided with at least three stages of filter screens; the primary graphene sterilization device, the secondary graphene sterilization device and the tertiarygraphene sterilization device each are independently filled with a superparamagnetic nanoparticle-graphene oxide nanocomposite, a first graphene sterilant or a combination of a grapheme composite material and a sterilant; the multiple purification tank is provided with an ozone generator, a first ultraviolet generating device, a graphene based chemical oxygen demand (COD) treatment agent and a second graphene sterilant; the multiple purification tank is connected with a spray liquid storage container and an ultrasonic micro-nano bubble generator; a nozzle of the ultrasonic micro-nano bubble generator is placed in the multiple purification tank; the photocatalytic degradation device is filled with a grapheme-based photocatalytic degradation agent; the SARS-CoV-2 deep purification device is provided with a transparent casing; a second ultraviolet generating device and an irradiation device are arranged outside the transparent casing; and the graphene water-purification device is filled with a heavy metal-adsorption graphene nanocomposite, a large-specific surface area graphene nanomaterial or a graphene porous ceramic material.

2. The system of claim 1, wherein a peristaltic pump is provided at a water inlet of the SARS-CoV-2 deep purification device; at least three stages of deceleration screens are provided inside the SARS-CoV-2 deep purification device; the irradiation device is a ⁶⁰Co-γ irradiation device; and a dosimeter is provided outside the SARS-CoV-2 deep purification device for measuring irradiation.

3. The system of claim 2, wherein the at least three stages of filter screens consist of a primary filter screen, a secondary filter screen and a tertiary filter screen; the primary filter screen, the secondary filter screen and the tertiary filter screen increase in sequence in mesh number, and are respectively arranged at a front section, a middle section and a rear section of the filtering device along a direction of water flow.

4. The system of claim 1, wherein in the superparamagnetic nanoparticle-graphene oxide nanocomposite, a superparamagnetic nanoparticle is selected from the group consisting of γ-Fe₂O₃, Fe₃O₄, Y₂O₃, MnZn, CoFe₂O₄ and a combination thereof, and has a particle size of less than 10 nm;
the first graphene sterilant and the second graphene sterilant are independently selected from the group consisting of silver/graphene oxide, silver/cobalt ferrite/graphene, ferroferric oxide/graphene oxide, yttrium oxide/graphene, bismuth oxychloride/graphene, bismuth oxybromide/oxide, titanium dioxide/graphene oxide, titanium dioxide/silver/graphene oxide, zinc oxide/graphene oxide and a combination thereof;
the combination of the graphene composite material and the sterilant is selected from the group consisting of a chloromethylated molecular ball-graphene nanocomposite, a chloromethylated molecular ball grafted quaternary ammonium quaternary phosphonium salt solid sterilant-graphene nanocomposite, 1-bromo-3-chloro-5,5-dimethylhydantoin-graphene nanocomposite, 2,2-dibromo-3-nitrilopropionamide-graphene nanocomposite, 1,3-dibromo-5,5-dimethylhydantoin-graphite Ene nanocomposite, 2-bromo-2-nitro-styrene-graphene nanocomposite, benzyl dibromoacetate-graphene nanocomposite, dodecyldimethylbenzylammonium bromide-graphene nanocomposite, bronopol-graphene nanocomposite, tribromophenol-graphene nanocomposite, 4-bromo-2,5-dichlorophenol-graphene nanocomposite, 1,2-dibromo-2,4-dicyanobutane-graphene nanocomposite, α-bromocinnamaldehyde-graphene nanocomposite, 2-butene-1,4-diol bis(bromoacetate) ester-graphene nanocomposite, 2,2-dibromo-2-nitroethanol-graphene nanocomposite, N-(4-bromo-2-methylphenyl) chloroacetamide-graphene nanocomposite, 2,2-dibromo-3-cyanopropionamide-graphene nanocomposite, ternary solid stable chlorine dioxide-graphene nanocomposite, ferrate-graphene nanocomposite, azoxystrobin-graphene nanocomposite, ethylphospho aluminum-graphene nanocomposite, polyiodine-graphene nanocomposite and a combination thereof; and
A the graphene composite material is selected from the group consisting of graphene, graphene oxide, boron-doped graphene, nitrogen-doped graphene nanosheet, graphene nanoribbon, graphene nanotube, graphene nanocluster, graphene nanofiber, graphene three-dimensional framework, graphene quantum dot and a combination thereof.

5. The system of claim 1, wherein a spray liquid contained in the spray liquid storage tank is selected from the group consisting of nano-ionized water, alkaline ionized water, alkaline reduced water, electrolyzed water, negative ion water and fluorinated water.

6. The system of claim 5, wherein the graphene chemical oxygen demand degrading agent is selected from the group consisting of large-specific surface area graphene, boron-doped graphene, CoFe₂O₄/graphene oxide nanocomposite, ferrous sulfate/graphene nanocomposite, bentonite/graphene nanocomposite, vermiculite/graphene nanocomposite, serpentine/graphene nanocomposite, titanium dioxide/graphene nanocomposite, graphene oxide/titanium dioxide nanoparticle, graphene oxide/titanium dioxide nanoribbon, graphene oxide/titanium dioxide nanotube, graphene/titanium dioxide nanorod, phosphotungstic acid/graphene oxide, tungsten trioxide/graphene oxide, zinc oxide/graphene oxide composite material and a combination thereof.

7. The system of claim 1, wherein the grapheme-based photocatalytic degradation agent is selected from the group consisting of graphene oxide/titanium dioxide nanoparticle, graphene/titanium dioxide nanoparticle, graphene oxide/titanium dioxide nanoribbon, graphene/titanium dioxide nanoribbon, graphene oxide/titanium dioxide nanotube, graphene/titanium dioxide nanotube, graphene oxide/titanium dioxide nanorod, graphene/titanium dioxide nanorod, phosphotungstic acid/graphene oxide, phosphotungstic acid/graphene, tungsten trioxide/graphene oxide, tungsten trioxide/graphene, zinc oxide/graphene oxide, zinc oxide/graphene, cuprous oxide/graphene, cuprous oxide/graphene oxide, bismuth tungstate/graphene, silver phosphate/graphene, molybdenum disulfide/graphene, trimanganese tetraoxide/graphene oxide and a combination thereof.

8. The system of claim 1, wherein the heavy metal-adsorption graphene nanocomposite is selected from the group consisting of graphene oxide, hydroxylated graphene, carboxylated graphene, chitosan modified graphene oxide, glutaraldehyde-coupled graphene oxide, chitosan modified hydroxylated graphene, acid salt nanotube-graphene oxide, hydroxyapatite-graphene oxide, N-(trimethoxysilylpropane) ethylenediamine triacyl graphene oxide, hydroxylated carbon nanotube-graphene oxide, Ti-pillared montmorillonite-graphene oxide, aluminum oxide-graphene oxide, polyaluminum chloride-graphene oxide, polyhydroxyaluminum pillared vermiculite, polyhydroxyaluminum pillared vermiculite-graphene oxide, 13X molecular sieve, sodium alginate-graphene oxide, EDTA-graphene oxide, polyamide-amine dendrimer porous silica gel, polyamide-amine dendrimer-graphene oxide and N-(2,3-epoxypropyl)iminodiacetic acid modified graphene oxide;
the large-specific surface area graphene nanomaterial is selected from the group consisting of a single-layer graphene nanosheet, a three-dimensional mesoporous graphene nanomaterial, a three-dimensional macroporous graphene nanomaterial, a graphene aerogel, a graphene nanofiber and a graphene organic framework composite nanomaterial.

9. The system of claim 8, wherein the graphene porous ceramic material is prepared through steps of:
(S101) selecting silicon carbide or boron carbide porous ceramic material as a substrate;
(S102) subjecting the substrate to ultrasonic treatment, gradient immersion in a copper chloride solution or a cobalt dichloride solution and vacuum drying and programmed heating in an inert gas to obtain a metal film-coated silicon carbide or boron carbide porous ceramic raw material;
(103) sealing the metal film-coated silicon carbide or boron carbide porous ceramic raw material obtained in step (S102) in a chemical vapor deposition reaction chamber; elevating a temperature in the chemical vapor deposition reaction chamber; introducing methane or acetylene to the chemical vapor deposition reaction chamber; and subjecting the sealed metal film-coated silicon carbide or boron carbide porous ceramic raw material to reaction in argon under adjustment of hydrogen flow to obtain a reaction product; and
(S104) stopping feeding methane or acetylene after the reaction is completed; keep flows of hydrogen and argon unchanged; and cooling the reaction product to obtain the graphene porous ceramic material.

10. A method for treating a medical sewage containing SARS-CoV-2 using the system of claim 1, comprising:
(S201) settling solid wastes and suspended solids in the medical sewage in the primary sedimentation tank;
(S202) subjecting a sewage flowing out of the primary sedimentation tank to filtration by the filtering device;
(S203) subjecting a sewage flowing out of the filtering device to primary sterilization in the primary graphene sterilization device;
(S204) subjecting a sewage flowing out of the primary graphene sterilization device to multiple sterilization in the multiple purification tank to preliminarily kill the SARS-CoV-2 and reduce chemical oxygen demand;
(S205) subjecting a sewage flowing out of the multiple purification tank to photocatalytic degradation by the photocatalytic degradation device to remove various pollutants;
(S206) allowing a sewage flowing out of the photocatalytic degradation device to enter the secondary sedimentation tank to settle suspended solids and separate the remains of parasites or pathogenic bacteria that have been killed;
(S207) allowing a sewage flowing out of the secondary sedimentation tank to successively pass through the secondary graphene sterilization device and the tertiary graphene sterilization device for further sterilization;
(S208) allowing a sewage flowing out of the tertiary graphene sterilization device to enter a primary graphene water-purification unit of the at least three stages of graphene water-purification unit store move heavy metals;
(S209) allowing a sewage flowing out of the primary graphene water-purification unit to enter the SARS-CoV-2 deep purification device for further killing the SARS-CoV-2; and
(S210) allowing a sewage flowing out of the SARS-CoV-2 deep purification device to sequentially pass through a secondary graphene water-purification unit and a tertiary graphene water-purification unit of the at least three stages of graphene water-purification units to remove peculiar smell substances and heavy metals to complete treatment of the medical sewage containing SARS-CoV-2.
